(19) United States
(12) Patent Application Publication
(10) Pub. No.: US 2014/0143498 A1
(43) Pub. Date: May 22, 2014

(54) METHODS AND APPARATUS FOR FILTERING STACK DATA WITHIN A CACHE MEMORY HIERARCHY

(71) Applicant: ADVANCED MICRO DEVICES, INC., Sunnyvale, CA (US)

(72) Inventors: Lena E. Olson, Madison, WI (US); Yasuko Eckert, Kirkland, WA (US); Vilas K. Sridharan, Brookline, MA (US); James M. O'Connor, Austin, TX (US); Mark D. Hill, Madison, WI (US); Srilatha Manne, Portland, OR (US)

(21) Appl. No.: 13/945,620

(22) Filed: Jul. 18, 2013

Related U.S. Application Data
(60) Provisional application No. 61/728,843, filed on Nov. 21, 2012.

(51) Int. Cl. G06F 12/08

(52) U.S. Cl. CPC G06F 12/0875
USPC 711/132

(57) ABSTRACT

A method of storing stack data in a cache hierarchy is provided. The cache hierarchy comprises a data cache and a stack filter cache. Responsive to a request to access a stack data block, the method stores the stack data block in the stack filter cache, wherein the stack filter cache is configured to store any requested stack data block.

### CROSS-REFERENCE TO RELATED APPLICATION(S)

This application claims the benefit of U.S. provisional patent application Ser. No. 61/728,843, filed Nov. 21, 2012.

### TECHNICAL FIELD

Embodiments of the subject matter described herein relate generally to the utilization of multiple, separate data cache memory structures within a computer system. More particularly, embodiments of the subject matter relate to filtering stack data into a separate cache structure.

### BACKGROUND

A central processing unit (CPU) may include or cooperate with one or more levels of a cache hierarchy in order to facilitate quick access to data. This is accomplished by reducing the latency of a CPU request of data in memory for a read or a write operation. Generally, a data cache is divided into sections of equal capacity, called cache “ways”, and the data cache may store one or more blocks within the cache ways. Each block is a copy of data stored at a corresponding address in the system memory.

Cache ways are accessed to locate a specific block of data, and the energy expenditure associated with these accesses increases with the number of cache ways that must be accessed. For this reason, it is beneficial to utilize methods of operation that limit the number of ways that are necessarily accessed in the search for a particular block of data, to include restricting the search to a smaller cache buffer located in the cache memory hierarchy of the system.

### BRIEF SUMMARY OF EMBODIMENTS

Some embodiments provide a method for storing stack data in a cache hierarchy that comprises a data cache and a stack filter cache. In response to a request to access a stack data block, the method stores the stack data block in the stack filter cache, wherein the stack filter cache is configured to store any requested stack data block.

Some embodiments provide a computer system having a hierarchical memory structure. The computer system includes a main memory element; a plurality of cache memories communicatively coupled to the main memory element, the plurality of cache memories comprising: a first level write-back cache, configured to receive and store any requested block of stack data, and configured to utilize error correcting code to verify accuracy of received stack data; and a second level write-through cache, configured to store data recently manipulated within the computer system; a processor architecture communicatively coupled to the main memory element and the plurality of cache memories, wherein the processor architecture is configured to: receive a request to access a block of stack data; and store the block of stack data in at least one of a plurality of ways of the first level write-back cache.

Some embodiments provide a method of filtering a cache hierarchy, comprising at least a stack filter cache and a data cache. In response to a stack data request, the method stores a cache line associated with stack data in one of a plurality of ways of the stack filter cache, wherein the plurality of ways is configured to store all requested stack data.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a simplified block diagram of an embodiment of a processor system;

FIG. 2 is a block diagram representation of a data transfer relationship between a main memory and a data cache;

FIG. 3 is a flow chart that illustrates an embodiment of filtering stack data within a cache hierarchy;

FIG. 4 is a block diagram representation of a data transfer relationship between a main memory element and a filtered cache hierarchy, including a data cache and a stack filter cache; and

FIG. 5 is a flow chart that illustrates an embodiment of determining a hit or miss for a filtered cache hierarchy.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

The subject matter presented herein relates to methods used to regulate the energy expended in the operation of a data cache within a computer system. In some embodiments, a request to manipulate a block of stack data is received, including an address for the location in main memory where the block of stack data is located. Once the request is received, the system will access cache memory to detect whether the requested block of stack data resides within the data cache, to accommodate faster and less resource-intensive access than if the system were required to access the block of stack data at the location in main memory in which the block of stack data resides. In accordance with embodiments described herein, the system routes all blocks of stack data to a separate stack filter cache, and during all future accesses of that particular block of stack data, the system will only access the stack filter cache.

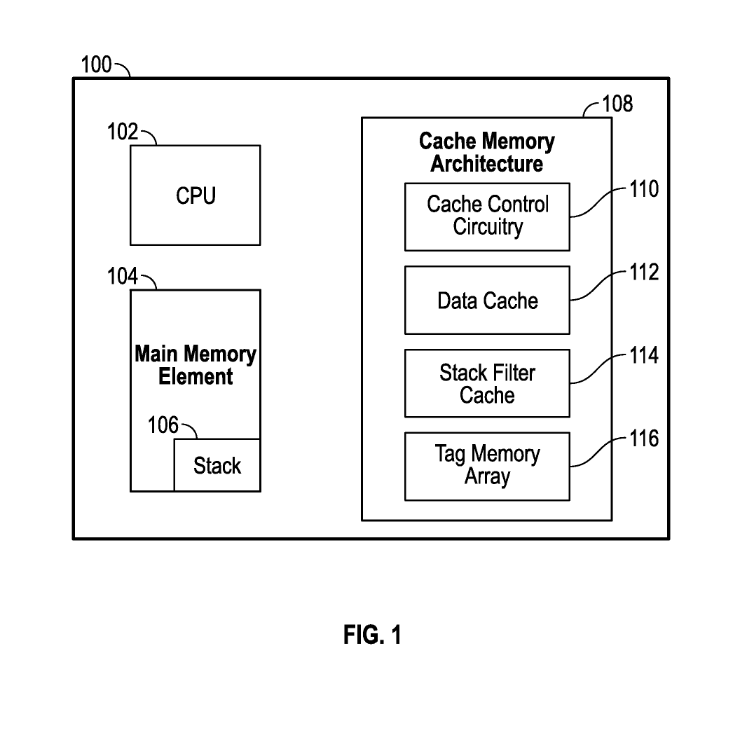

Referring now to the drawings, FIG. 1 is a simplified block diagram of an embodiment of a processor system 100. In accordance with some embodiments, the processor system 100 may include, without limitation: a central processing unit (CPU) 102; a main memory element 104; and a cache memory architecture 108. These elements and features of the processor system 100 may be operatively associated with one another, coupled to one another, or otherwise configured to cooperate with one another as needed to support the desired functionality—in particular, the cache hierarchy filtering described herein. For ease of illustration and clarity, the various physical, electrical, and logical couplings and interconnections for these elements and features are not depicted in FIG. 1. Moreover, it should be appreciated that embodiments of the processor system 100 will include other elements, modules, and features that cooperate to support the desired functionality. For simplicity, FIG. 1 only depicts certain elements that relate to the stack filter cache management techniques described in more detail below.

The CPU 102 may be implemented using any suitable processing system, such as one or more processors (e.g., multiple chips or multiple cores on a single chip), controllers, microprocessors, microcontrollers, processing cores and/or other computing resources spread across any number of distributed or integrated systems, including any number of “cloud-based” or other virtual systems. The CPU 102 represents a processing unit, or plurality of units, that are designed and configured to execute computer-readable instructions, which are stored in some type of accessible memory, such as main memory element 104.

Main memory element 104 represents any non-transitory short or long term storage or other computer-readable media capable of storing programming instructions for execution on the processor(s) 110, including any sort of random access memory (RAM), read only memory (ROM), flash memory, magnetic or optical mass storage, and/or the like. As will be recognized by those of ordinary skill in the art, a main memory element 104 is generally comprised of RAM, and, in some embodiments, the main memory element 104 is implemented using Dynamic Random Access Memory (DRAM) chips that are located near the CPU 102.

The stack 106 resides within the main memory element 104, and may be defined as a region of memory in a computing architecture where data is added or removed in a last-in, first-out (LIFO) manner. Stack data may be defined as any data currently located in the stack. Generally, the stack is utilized to provide storage for local variables and other overhead data for a particular function within an execution thread, and in multi-threaded computing environments, each thread will have a separate stack for its own use. However, in some embodiments, a stack may be shared by multiple threads. The stack is allocated, and the size of the stack is determined, by the underlying operating system. When a function is called, a pre-defined number of cache lines are allocated within the program stack. One or more cache lines may be “pushed” onto the stack for storage purposes, and will be “popped” off of the stack when a function returns (i.e., when the data on the stack is no longer needed and may be discarded). In some embodiments, it is also possible that the stack may be popped before the function returns. Due to the nature of the LIFO storage mechanism, data at the top of the stack is the data that has been “pushed” onto the stack the most recently will be the data that is “popped” off of the stack first. The stack is often implemented as virtual memory that is mapped to physical memory on an as-needed basis.

The cache memory architecture 108 includes, without limitation, cache control circuitry 110, a data cache 112 a stack filter cache 114, and a tag memory array 116. These components may be implemented using multiple chips or all may be combined into a single chip.

The cache control circuitry 110 contains logic to manage and control certain functions of the cache memory architecture 108. For example, and without limitation, the cache control circuitry 110 may be configured to maintain consistency between the cache memory architecture 108 and the main memory element 104, to update the data cache 112 and stack filter cache 114 when necessary, to implement a cache write policy, to determine if requested data located within the main memory element 104 is also located within the cache, and to determine if a specific block of requested data is located within the main memory element 104 is cacheable.

The data cache 112 is the portion of the cache memory hierarchy that holds most of the data stored within the cache. The data cache 112 is most commonly implemented using static random access memory (SRAM), but may also be implemented using other forms of random access memory (RAM) or other computer-readable media capable of storing programming instructions. The size of the data cache 112 is determined by the size of the cache memory architecture 108, and will vary based upon individual implementation. A data cache 112 may be configured or arranged such that it contains “sets”, which may be further subdivided into “ways” of the data cache. Within the context of this application, sets and/or ways of a data cache or stack filter cache may be collectively referred to as storage elements, cache memory storage, storage sub-elements, and the like.

The data cache 112 uses a write-through cache write policy, which means that all writes to the data cache 112 are done synchronously to the data cache 112 and the back-up storage. Generally, the data cache 112 refers to a Level 1 (L1) data cache. Multi-level caches operate by checking the smallest Level 1 (L1) cache first, proceeding to check the next larger cache (L2) if the smaller cache misses, and so on, checking through the lower levels of the memory hierarchy (e.g., L1 cache, then L2 cache, then L3 cache, and finally main system memory) before external memory is checked. In some embodiments, the back-up storage comprises the main system memory, and in other embodiments this back-up storage comprises a lower level data cache, such as an L2 cache.

The data cache 112 is generally implemented as a set-associative data cache, in which there are a fixed number of locations where a data block may reside. In some embodiments, the data cache 112 comprises an 8-way, set-associative cache, in which each block of data residing in the main memory element 104 of the system maps to a unique set, and may be cached within any of the ways within that unique set, inside the data cache 114. It follows that, for an 8-way, set-associative data cache 112, when a system searches for a particular block of data within the data cache 112, there is only one possible set in which that block of data may reside and the system only searches the ways of the one possible set.

The stack filter cache 114, also known as a stack buffer, is the portion of the cache memory hierarchy that holds any cached data that has been identified as stack data. Similar to the data cache 112, the stack filter cache 114 is most commonly implemented using SRAM, but may also be implemented using other forms of RAM or other computer-readable media capable of storing programming instructions. Also similar to the data cache, the stack filter cache 114 includes a plurality of sets which are further subdivided into ways, and the stack filter cache 114 operates as any other cache memory structure, as is well-known in the art. The size of the stack filter cache 114 is comparatively smaller than the size of the data cache, and in some embodiments, includes only one set divided into a range of 8-16 ways.

The stack filter cache 114 is generally implemented as an L0 cache within the cache memory hierarchy. As discussed above with regard to the data cache 112 and is well-known in the art, cache memories are generally labeled L1, L2, L3 and, as the label number increases for each one, both size and latency increase while speed of accessing the cache decreases. The stack filter cache 114, implemented as an L0 cache within the cache hierarchy, is the smallest in size and the fastest to access, with the lowest latency levels of any of the caches in the system. The stack filter cache 114, implemented as an L0 cache, is also the first cache to be accessed when the system is searching for data within the cache hierarchy.

In some embodiments, the stack filter cache 114 comprises an 8 way, direct-mapped cache. For a direct-mapped cache, as is well-known in the art, the main memory address for each block of data in a system indicates a unique position in which that particular block of data may reside. It follows that, for an 8-way, direct-mapped stack filter cache 114, when a system searches for a particular block of data within the stack filter cache 114, there is only one possible way in which that block of data may reside and the system only searches the one possible way.

In some embodiments, the stack filter cache 114 is implemented as a write-back cache, where any writes to the stack filter cache 114 are limited to the stack filter cache 114 only. Once a particular block of data is about to be evicted from the stack filter cache 114, then the data will be written to the back-up storage. Similar to the data cache 112, in some embodiments, the back-up storage comprises the main system memory, and in other embodiments this back-up storage comprises a lower level data cache, such as an L2 cache.

The tag memory array 116 stores the addresses of each block of data that is stored within the data cache 112 and the stack filter cache 114. The addresses refer to specific locations in which data blocks reside in the main memory element 104, and may be implemented using physical memory addresses, virtual memory addresses, or a combination of both. The tag memory array 116 will generally consist of Random Access Memory (RAM), and in some embodiments, comprises Static Random Access Memory (SRAM). The tag memory array 116 may be further subdivided into storage elements for each tag stored.

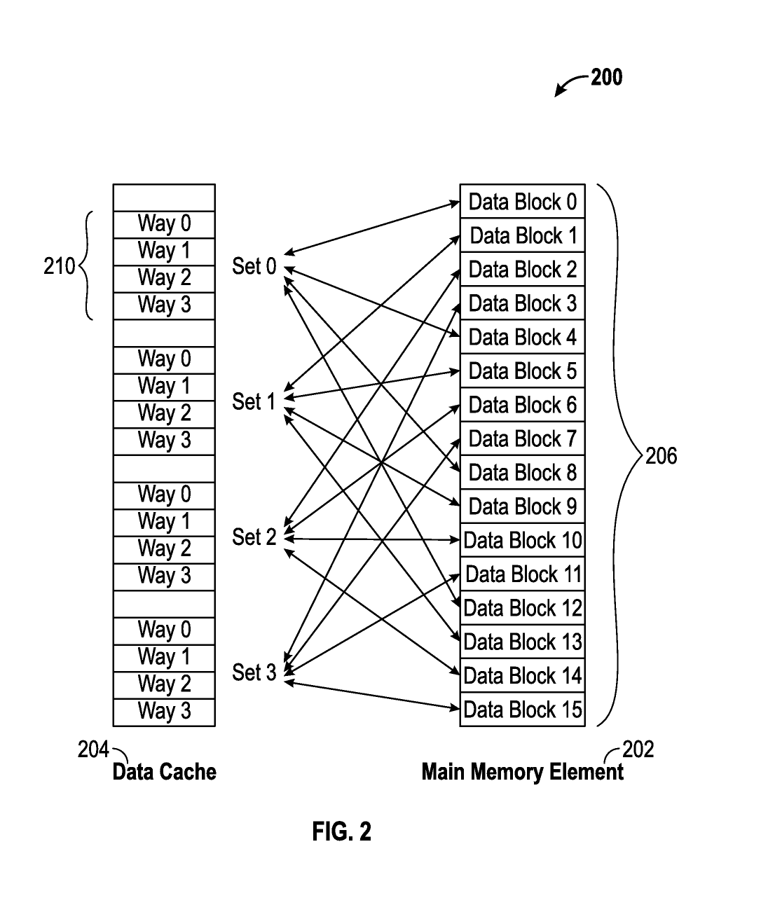

FIG. 2 is a block diagram representation of a data transfer relationship between a main memory and a data cache, as is well-known in the art. As shown, a partial memory hierarchy 200 contains a main memory element 202 (such as the main memory element 104 shown in FIG. 1) and a data cache 204. The data cache 204 contains four sets (Set 0, Set 1, Set 2, Set 3), which in turn are divided into four ways 210. The total number of sets within a data cache 204 is determined by the size of the data cache 204 and the number of ways 210, and the sets and ways 210 are numbered sequentially. For example, a four-way, set-associative data cache with four sets will contain sets numbered Set 0 through Set 3 and ways numbered Way 0 through Way 3 within each set.

The main memory element 202 is divided into data blocks 206. As used herein, a “block” is a set of bytes stored in contiguous memory locations, which are treated as a unit for coherency purposes, and the terms “block” and “line” are interchangeable. Generally, each data block 206 stored in main memory and the capacity of each cache line are the same size. For example, a system including a main memory consisting of 64 byte data blocks 206 may also include cache lines that are configured to store 64 bytes. However, in some embodiments, a data block 206 may be twice the size of the capacity of each cache line. For example, a system including a main memory consisting of 128 byte data blocks 306 may also include cache lines that are configured to store 64 bytes.

Each data block 206 corresponds to a specific set of the data cache 204. In other words, a data block 206 residing in a specific area (i.e., at a specific address) in the main memory element 202 will automatically be routed to a specific area, or set, when it is cached. For example, when a system receives a request to manipulate data that is not located within the data cache 204, the data can be imported from the main memory element 202 to the data cache 204. The data is imported into a specific, pre-defined set 208 within the data cache 204, based upon the address of the data block 206 in the main memory element 202.

In some embodiments, the imported data block 206 and the cache line into which the data block 206 is mapped are equivalent in size. However, in some embodiments, the data block 206 may be twice the size of the capacity of the cache line, including an amount of data that would fill the capacity of two cache lines. In this example, the large data block 206 may include multiple addresses, but only the first address (i.e., the address for the starting cache line) is used in mapping the data block 206 into the data cache 204. In this case, configuration information that is specific to the hardware involved is used by the processor to make the necessary calculations to map the second line of the data block 206 into the data cache 204.

The exemplary structures and relationships outlined above with reference to FIGS. 1 and 2 are not intended to restrict or otherwise limit the scope or application of the subject matter described herein. FIGS. 1 and 2, and their descriptions, are provided here to summarize and illustrate the general relationship between data blocks, sets, and ways, and to form a foundation for the techniques and methodologies presented below.

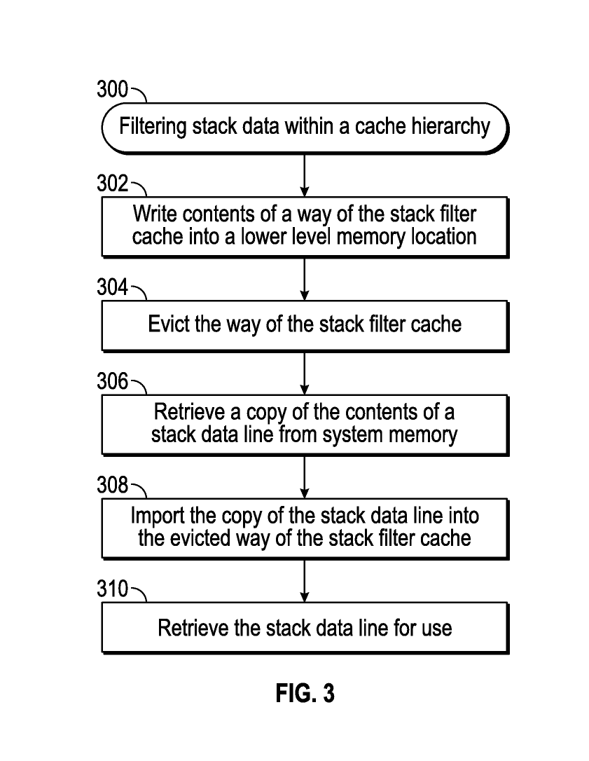

FIG. 3 is a flow chart that illustrates an embodiment of a process 300 for filtering stack data into a stack filter cache within a cache hierarchy. As used here, “filtering stack data” means storing all stack data within an explicit stack filter cache, which is a separate and distinct structure, while all non-stack data is directed to the data cache.

For ease of description and clarity, this example assumes that the process 300 begins when a block of stack data is required for use by a computer system, but is not currently accessible from the stack filter cache of the system. The process 300 writes the contents of a way of a stack filter cache into a lower level memory location (302). The way of the stack filter cache is chosen according to an implemented replacement policy of the stack filter cache. Examples of commonly used cache replacement policies may include, without limitation, Least Recently Used, Least Frequently Used, Most Recently Used, Random Replacement, Adaptive Replacement, etc. In some embodiments, the stack filter cache is implemented as a direct-mapped cache, and when a block of stack data is required for use by the computer system, the system will look for the block of stack data in the unique location (i.e., unique way) within the stack filter cache in which the block of stack data is permitted to reside. If the block of stack data is not located in this designated way of the stack filter cache, the computer system will then write the current contents of the designated way into a lower level memory location before proceeding to the next steps in the process 300.

In some embodiments, the lower level memory location comprises a specified address in the main memory of the computer system. In some embodiments, the lower level memory location comprises a lower level cache, such as an L1 or an L2 cache, which is in communication with the stack filter cache, the main system memory, and the CPU.

After writing the contents of the way to a lower level memory location, the process 300 evicts the way of the stack filter cache (304). This is accomplished by removing the contents of a way of a stack filter cache to accommodate new data that will replace it in the way. In accordance with conventional methodologies, the evicted data is removed from the way of the stack filter cache, but continues to reside in its original place within main memory. In addition, the write-back policy of the stack cache ensures that the contents of the way are written to a lower level cache memory location prior to eviction. Accordingly, at this point one copy of the data resides within main memory, and another copy of the data resides within a lower level cache memory location.

Once the designated way of the stack filter cache has been evicted, the process 300 retrieves a copy of the contents of the block of stack data that has been requested by the system from its location in system memory (306). In some embodiments, this copy is retrieved from the location in which the block of stack data resides in main system memory. In some embodiments, this copy is retrieved from a lower level cache element within the memory hierarchy. In some embodiments, it is also possible for the copy of the block of stack data to be retrieved from another location in the memory hierarchy of the computer system.

In order to retrieve a copy of the contents of the block of stack data, the system must use an address that references the location of the block of stack data in the main system memory. When a CPU or processor is utilizing multiple programs and/or multiple threads of execution, these threads commonly share the memory resources by using virtual memory having virtual addresses. This allows for efficient and safe sharing of memory resources among multiple programs. As is well-known in the art, virtual addresses correspond to locations in virtual memory and are translated into main memory physical addresses using a page table, stored in main memory. If the translation has already occurred recently, a translation lookaside buffer (TLB) provides the address translation when needed again within a short period of time. A TLB is a cache that keeps track of recently used address mappings to avoid accessing a page table and unnecessarily expending energy.

Because the stack is guaranteed to comprise data that is local to a particular thread, using an explicit, separate stack filter cache allows the system to avoid a translation lookaside buffer (TLB) lookup and simply use the Page Offset located in the virtual address to locate and retrieve the block of stack data. Not only is the system able to avoid the energy expenditure associated with a page table lookup, the system is also able to avoid the energy expenditure associated with a TLB lookup, and utilize the more energy efficient method of locating the stack data block within virtual memory using the Page Offset field of the virtual address.

Next, the process 300 imports the copy of the block of stack data into the evicted way of the stack filter cache (308), where it will reside until the contents of this way are again evicted so that new data may be stored here. In some embodiments, wherein the stack filter cache comprises a direct-mapped cache, the block of stack data resides within the designated way of the stack filter cache until another block of stack data is requested for use by the system, and under the condition that the new block of requested stack data has also been designated for placement within only this particular way of the stack filter cache. After the copy of the block of stack data is imported into the evicted way, the process 300 may retrieve it from the stack filter cache for use by the system (310).

In some embodiments, the stack filter cache utilizes error correction code (ECC) to verify the accuracy of the contents of the block of stack data received from another memory location. ECC is a method of adding redundant data to a block of data communicated between a transmitter and receiver, and decoding at the receiver, so that the receiver may distinguish the correct version of each bit value transmitted. In some embodiments, the transmitter and receiver combination may comprise parts of a computer system communicating over a data bus, such as a main memory of a computer system and a stack filter cache. Examples of ECC may include, without limitation, convolutional codes or block codes, such as Hamming code, multidimensional parity-check codes, Reed-Solomon codes, Turbo codes, low-density parity check codes, and the like. Because the stack filter cache is an explicit structure, utilization of the “extravagant” (i.e., more energy-expensive) ECC methods to ensure accuracy of stack data received does not affect the simpler error correction methods of the other caches in the hierarchy. For example, the L1 and L2 data caches, which are much larger and slower to access, may utilize a simple general bit correction of errors within a data stream for any data received, in order to maintain energy efficiency and/or if a simple error correction scheme is all that is necessary. The stack filter cache, implemented as the much smaller and faster to access L0 cache, may decode the more complicated and more resource-intensive ECC without a significant energy expense to the system, ensuring a higher level of accuracy for the cached blocks of stack data.

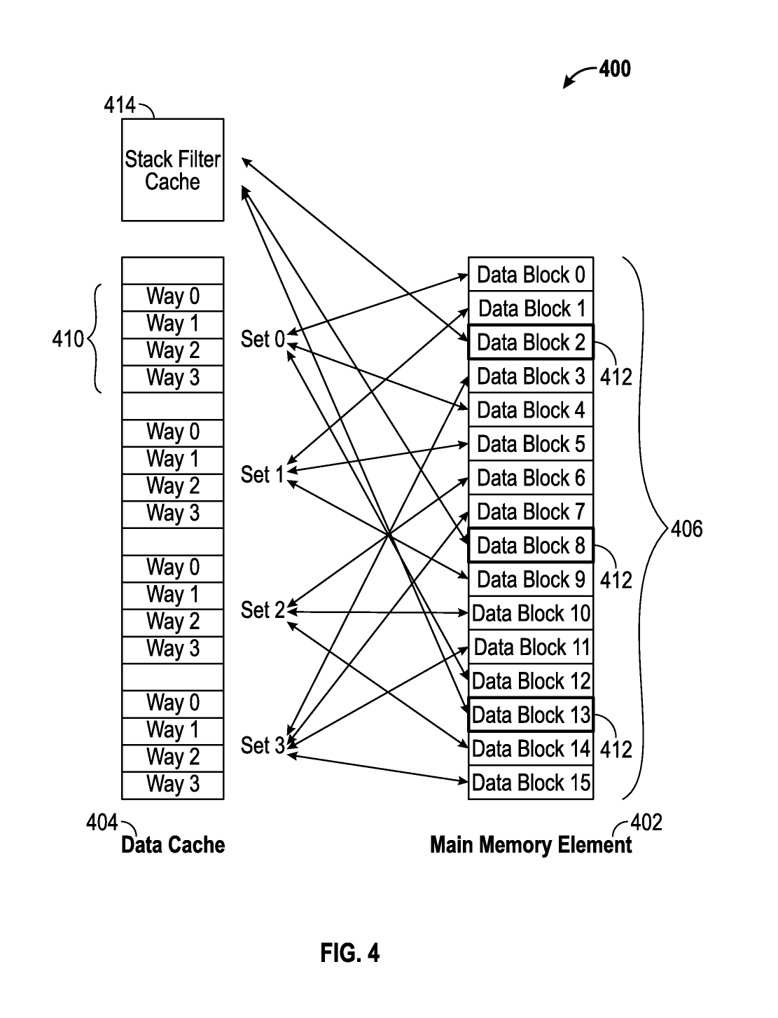

This concept of storing stack data within an explicit stack filter cache is illustrated in FIG. 4. FIG. 4 is a block diagram representation of a data transfer relationship between a main memory element and a filtered cache hierarchy, including a data cache and a stack filter cache. As shown, a partial memory hierarchy 400 contains a main memory element 402 (such as the main memory element 104 shown in FIG. 1), a data cache 404, and a stack filter cache 414. The data cache 404 has four sets (Set 0, Set 1, Set 2, Set 3), each of which are further divided into four ways 410. Here, the sets and the ways 410 are numbered sequentially. For example, a four-way, set-associative data cache with four sets will contain sets numbered Set 0 through Set 3 and ways numbered Way 0 through Way 3 within each set.

Similar to the composition of the data cache 404, the stack filter cache 414 includes a plurality of sets, further subdivided into a plurality of ways, which are numbered sequentially (not shown). As with the data cache 404, the number of sets and ways in a stack filter cache 414 is determined by the physical size of the stack filter cache. Generally, the size of the stack filter cache 414 will be much smaller than that of the data cache 404, and therefore will include fewer sets and/or ways.

The main memory element 402 is divided into data blocks 406, and each data block 406 corresponds to a specific set 408 of the data cache 404, as is well-known in the art. In this example, three data blocks 406 within the main memory element 402 are designated as stack data blocks 412. However, a certain number of stack data blocks 412 is not required, and will vary based on use of the stack. As shown, the stack data blocks 412 are directed into the stack filter cache 414 of the partial memory hierarchy 400. Stack data blocks 412 are not stored within the ways 410 of the data cache 404.

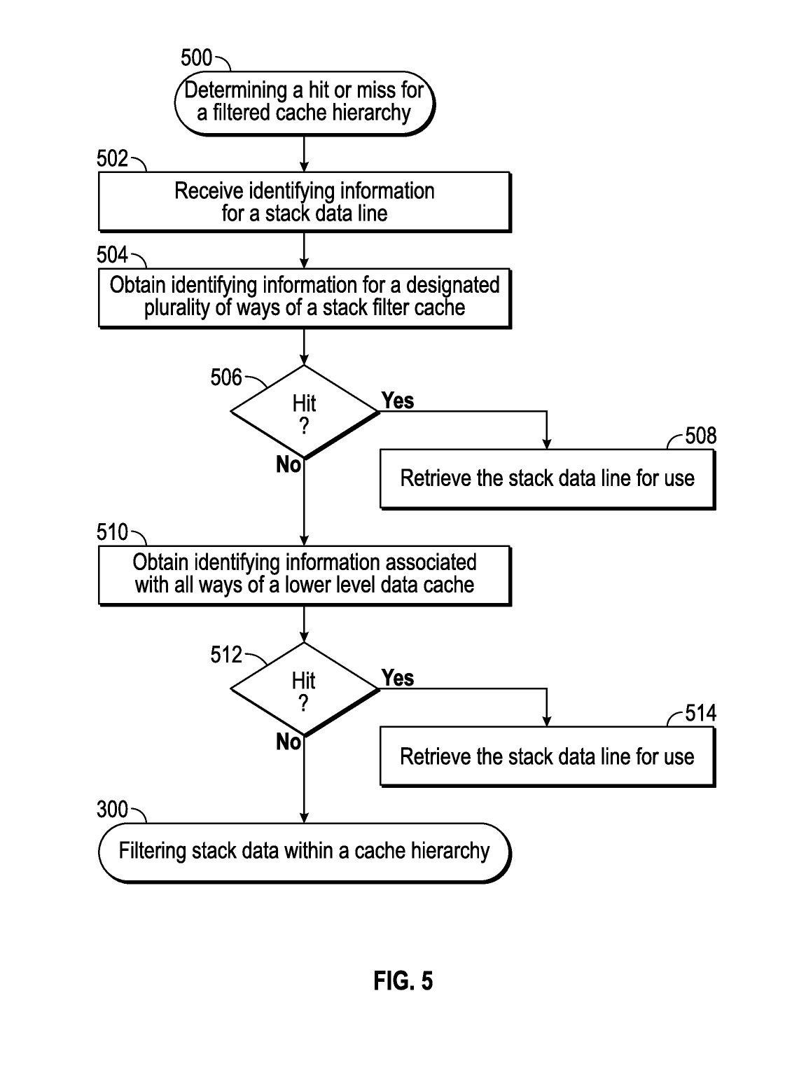

Before stack data can be stored within the stack filter cache, as described in the context of FIG. 3 and as shown in FIG. 4, the system will determine whether the particular block of stack data already resides within the stack filter cache. FIG. 5 is a flow chart that illustrates an embodiment of a process 500 of determining a hit or a miss for a filtered cache hierarchy, based on stack or non-stack classification of data. For ease of description and clarity, this example assumes that the process 500 begins upon receipt of identifying information for a block of stack data (502). In certain embodiments, the identifying information is extracted from an instruction to manipulate a block of stack data, sent by a CPU (such as the CPU 102 shown in FIG. 1). This identifying information is associated with the stack data block and is then available to the system for further use. In some embodiments, the identifying information may include main memory location information, detailing a location within main memory where the data block in question is stored. In some embodiments, this main memory address may be a physical address, a virtual address, or a combination of both.

The process 500 obtains identifying information associated with a designated plurality of ways of a stack filter cache (504). In some embodiments, the designated plurality of ways of the stack filter cache comprises all of the ways of the stack filter cache. In some embodiments, the designated plurality of ways of the stack filter cache comprises only the particular way that has been assigned to be the location where the block of stack data in question will reside. In some embodiments, the identifying information includes main memory location data for each of the stack data blocks residing in the designated plurality of ways. In certain embodiments, the process 500 reads a specified number of tags to obtain the identifying information for the designated plurality of ways.

The process 500 may continue by determining whether or not a hit has occurred (506) by comparing the obtained identifying information associated with each of the stack data blocks residing in the designated plurality of ways of the stack filter cache to the identifying information for the requested block of stack data (i.e., the block of stack data that is the subject of the instruction received at 502). In this regard, the contents of each of the designated plurality of ways are associated with separate and distinct identifying information, and the contents of each are compared to the identifying information associated with the requested block of stack data. The objective of this comparison is to locate a match, or in other words, to determine whether the identifying information (the tag) for any of the designated plurality of ways is identical to the identifying information (the tag) of the requested stack data block.

In accordance with well-established principles, a “hit” occurs when a segment of data that is stored in the main memory of a computer system is requested by the computer system for manipulation, and that segment of data has a more quickly accessible copy located in a data cache of the computer system. Otherwise, the process 500 does not indicate that a hit has occurred. Thus, if the comparison results in a match between the identifying information for the requested block of stack data and the identifying information for the contents of one of the designated plurality of ways of the stack filter cache (i.e., both sets of identifying information are the same), then the process 500 can indicate that both sets of data are the same. Accordingly, if the data being requested from memory (in this case, the stack data block) and the data located within one of the recently accessed ways of the data cache (in this case, a copy of the stack data block) are determined to be the same, then the process 500 will follow the “Yes” branch of the decision block 506. Otherwise, the process 500 follows the “No” branch of the decision block 506.

When a hit has been confirmed (the “Yes” branch of 506), the process 500 retrieves the requested block of stack data for use (508). In some embodiments, the process retrieves the block of stack data according to a previously received instruction. Because there has been a hit, it is known that one of the designated plurality of ways of the stack filter cache contains a copy of the requested block of stack data. Accordingly, the requested block of stack data can be accessed in the stack filter cache, which has the advantage of occurring more quickly than attempting to access the requested block of stack data at its original location within the system main memory.

When a hit has not been confirmed (the “No” branch of 506), the process 500 may continue substantially as described above, within the context of a lower level data cache. The process 500 omits the search of the designated plurality of ways of the stack filter cache, and instead takes into account the contents of an entire lower level data cache. To do this, the process 500 obtains identifying information associated with all ways of the data cache (510). In some embodiments, the identifying information includes tags, which contain the address information required to identify whether the associated block in the hierarchy corresponds to a block of data requested by the processor. For example, the identifying information may include unique information associated with the contents of each way of the data cache which correspond to unique information associated with contents of various locations within main memory.

Next, the process 500 may continue by determining whether or not a hit has occurred (512) by comparing the obtained identifying information associated with each of the data cache ways, individually, to the identifying information for the requested block of stack data, and seeking a match between the two.

When a match between the identifying information for the contents of one of the data cache ways and the identifying information for the requested block of stack data is found, a hit is confirmed (the “Yes” branch of 512) within the data cache. The system will then retrieve the requested block of stack data for use (514). When a hit has not been confirmed (the “No” branch of 512), the process 500 exits and the Filtering Stack Data within a Cache Hierarchy process 300 begins, as shown in FIG. 3 and described in detail above.

Structures and combinations of structures described previously present an advantage with regard to energy efficiency with in the memory hierarchy. For example, a stack filter cache having a high degree of ECC protection and a write-back policy in combination with a much larger, write-through L1 data cache provides several benefits in this area. Because the stack filter cache is very small, in some embodiments comprising only 8-16 ways, it can have extensive ECC protection without paying a large penalty in access time or physical area. The data cache, on the other hand, brings the benefit of a write-through policy, providing a modified data backup within a lower level cache, such as an L2. A significant portion of the modified data within the cache memory hierarchy is the result of writing to the stack, and by separating the stack data into an explicit stack filter cache, the write traffic to the lower level cache (L2) is significantly reduced, resulting in lower energy consumption. This is accomplished while still retaining the reliability features of a unified, write-through L1 data cache.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of storing stack data in a cache hierarchy, the cache hierarchy comprising a data cache and a stack filter cache, the method comprising:
responsive to a request to access a stack data block,
storing the stack data block in the stack filter cache;
wherein the stack filter cache is configured to store any requested stack data block.

2. The method of claim 1, further comprising:
prior to storing the stack data block, determining whether the stack data block already resides in the stack filter cache by:
obtaining identifying information associated with a plurality of ways of the stack filter cache;
comparing the obtained identifying information associated with the plurality of ways of the stack filter cache to identifying information for the stack data block; and
determining whether the comparing indicates a match between the identifying information for the stack data block and the obtained identifying information associated with the plurality of ways.

3. The method of claim 2, further comprising:
when the comparing does not indicate a match,
selecting at least one of the plurality of ways of the stack filter cache;
retrieving contents of the stack data block from a location within system memory; and
storing the retrieved contents of the stack data block within the selected way of the stack filter cache.

4. The method of claim 3, wherein the retrieving comprises retrieving the contents of the stack data block from an address within a memory element that is operatively associated with the stack filter cache.

5. The method of claim 3, wherein the retrieving comprises retrieving the contents of the stack data block from a lower level cache element of the stack filter cache.

6. The method of claim 3, wherein the selecting at least one of the plurality of ways of the stack filter cache comprises selecting an invalid way of the stack filter cache.

7. The method of claim 2, further comprising:
when the comparing indicates a match,
identifying one of the plurality of ways of the stack filter cache as a matched way; and
accessing contents of the matched way.

8. The method of claim 2, wherein the identifying information for each of the plurality of ways references associated contents of each of the plurality of ways and corresponds to identifying information for a copy of the associated contents of each of the plurality of ways, wherein the copy of the associated contents of each of the plurality of ways is stored in a second location in a memory hierarchy.

9. The method of claim 2, wherein the identifying information associated with the plurality of ways of the data cache comprises a plurality of tags, and wherein each of the plurality of tags is associated with an individual one of the plurality of ways within the stack filter cache.

10. The method of claim 2, further comprising:
obtaining contents of each of the plurality of ways of the stack filter cache concurrently with obtaining the identifying information for each of the plurality of ways of the stack filter cache.

11. A computer system having a hierarchical memory structure, comprising:
a main memory element;
a plurality of cache memories communicatively coupled to the main memory element, the plurality of cache memories comprising:
a first level write-back cache, configured to receive and store any requested block of stack data, and configured to utilize error correcting code to verify accuracy of received stack data; and
a second level write-through cache, configured to store data recently manipulated within the computer system;
a processor architecture communicatively coupled to the main memory element and the plurality of cache memories, wherein the processor architecture is configured to:
receive a request to access a block of stack data; and
store the block of stack data in at least one of a plurality of ways of the first level write-back cache.

12. The computer system of claim 11, wherein, prior to storing the block of stack data, the processor architecture is further configured to:
obtain identifying information associated with the plurality of ways of the first level write-back cache; and
compare the received identifying information for the block of stack data to the obtained identifying information associated with the plurality of ways of the first level write-back cache to determine whether a hit has occurred, wherein a hit occurs when the comparison results in a match; and
when a hit has not occurred, replace one of the plurality of ways of the first level write-back cache with the block of stack data.

13. The computer system of claim 12, wherein the processor architecture is further configured to:
obtain contents of each of the plurality of ways of the first level write-back cache concurrently with obtaining the identifying information associated with the plurality of ways of the first level write-back cache.

14. The computer system of claim 12, wherein the identifying information for the block of stack data comprises a tag associated with a physical address for the block of stack data; and
wherein the identifying information associated with the plurality of ways of the first level write-back cache comprises a plurality of tags, and wherein each of the plurality of tags is associated with an individual one of the plurality of ways of the first level write-back cache.

15. The computer system of claim 12, wherein the second level write-through cache comprises a data cache, and wherein the first level write-back cache comprises a stack filter cache, the stack filter cache comprising a physical structure that is separate and distinct from the data cache.

16. The computer system of claim 12, wherein one of the at least one of the plurality of ways of the first level write-back cache comprises an invalid way.

17. A method of filtering a cache hierarchy comprising at least a stack filter cache and a data cache, the method comprising:
responsive to a stack data request,
storing a cache line associated with stack data in one of a plurality of ways of the stack filter cache, wherein the plurality of ways is configured to store all requested stack data.

18. The method of claim 17, further comprising:
prior to storing the cache line associated with stack data, determining whether the cache line already resides in the stack filter cache by:
reading a plurality of cache tags, wherein each of the plurality of cache tags is associated with the contents of one of a plurality of ways of the stack filter cache;
comparing a first tag, associated with the cache line, to each of the plurality of cache tags to determine whether there is a match; and
when the comparing determines that there is not a match, selecting one of the plurality of ways of the stack filter cache to obtain a selected way, and storing the cache line within the selected way.

19. The method of claim 18, further comprising reading contents referenced by the plurality of cache tags concurrently with reading the plurality of cache tags.

20. The method of claim 18, wherein the selecting one of the plurality of designated ways further comprises selecting an invalid way.
